(19) United States
(12) Patent Application Publication
(10) Pub. No.: US 2025/0035664 A1
(43) Pub. Date: Jan. 30, 2025

(54) VELOCITY MEASURING DEVICE UTILIZING PHOTOELECTRIC SENSOR RINGS

(71) Applicant: The United States of America, as represented by the Secretary of the Navy, Crane, IN (US)

(72) Inventors: Lee R. Cambrea, Bloomington, IN (US); Terry Chastain, Bedford, IN (US); Shad Truelove, Montgomery, IN (US)

(73) Assignee: The United States of America, as represented by the Secretary of the Navy, Arlington, VA (US)

(21) Appl. No.: 18/226,956

(22) Filed: Jul. 27, 2023

(51) Int. Cl. G01P 3/68

(52) U.S. Cl. CPC G01P 3/68

(57) ABSTRACT

Disclosed is a velocity measuring device that utilizes photoelectric sensor rings. A first and second photoelectric sensor ring are spaced a known distance apart. The rings include a repeating pattern of first and second emitters and first and second receivers. The first emitters and the first receivers have a first matched modulation frequency, and the second emitters and second receivers have a second matched modulation frequency. A signal is transmitted between the emitters and receivers, and when an object is passed through the photoelectric sensor rings, the blocking of the signal causes a change in measured voltage. The velocity of the object is calculated by the dividing the known distance by time between voltage changes. The inventive device allows for measuring velocity of small, slow moving objects that cannot be measured utilizing currently known techniques.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 210065US01) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD OF THE INVENTION

The field of invention relates generally to measurement devices. More particularly, it pertains to a device for measuring velocity of an object utilizing photoelectric sensor rings.

### BACKGROUND

Chronograph type devices for measuring high-speed projectiles (bullets) rely on sunlight and shadows. Additionally, these devices are designed for measuring high speeds. Slower moving objects are typically measured by radar or light return (police/baseball “speed” gun) but this technology requires objects to be large enough to reflect significant signal. Slow moving objects, such as countermeasures, eject at speeds of 60-200 ft/s, which, as can be appreciated, is significantly slower than ballistic objects. Additionally, countermeasures are approximately one inch in diameter, which eliminates the ability to use radar/light reflection. Furthermore, countermeasures operate at high temperature or can even be engulfed in flame, thereby eliminating the ability to use sunlight and shadows for measurement.

Current techniques for measuring countermeasure ejection velocity is accomplished with high-speed camera imagery. Imagery-based method, however, is user intensive for data reduction and prone to errors associated with the frame rate of the camera and spacing between calibrated distances on a backer board. Additionally, such methods require significant user input/decisions to determine the result.

### SUMMARY OF THE INVENTION

The present invention relates to a velocity measuring device that utilizes photoelectric sensor rings. A first and second photoelectric sensor ring are spaced a known distance apart. The rings include a repeating pattern of first and second emitters and first and second receivers. The first emitters and the first receivers have a first matched modulation frequency, and the second emitters and second receivers have a second matched modulation frequency. A signal is transmitted between the emitters and receivers, and when an object is passed through the photoelectric sensor rings, the blocking of the signal causes a change in measured voltage. The velocity of the object is calculated by the dividing the known distance by time between voltage changes. The inventive device allows for measuring velocity of small, slow moving objects that cannot be measured utilizing currently known techniques.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 shows a side view of a measurement device.

FIG. 2 shows a perspective view of a measurement device.

FIG. 3 shows a view of ring spacing.

FIG. 4 shows a schematic of emitters and receivers spaced around a ring.

FIG. 5A shows a view of an open sensor path.

FIG. 5B shows a view of a sensor path blocked by an object.

FIG. 5C shows a graphical view of a sensor path blocked by an object.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

Generally, provided is a device for measuring velocity of objects comprising: a first and a second photoelectric sensor ring spaced a known distance apart; the first photoelectric sensor ring further comprising a repeating pattern of first and second emitters and first and second receivers; the second photoelectric sensor ring further comprising a corresponding pattern of first and second receivers and first and second emitters that correspond with the repeating pattern of the first photoelectric sensor ring; wherein the first emitters and the first receivers have a first matched modulation frequency, and the second emitters and second receivers have a second matched modulation frequency; wherein a signal is transmitted between the first and second emitters and the first and second receivers and is measured at a predefined rate; wherein an object is passed through the first and second photoelectric sensor rings, blocking the signal and causing a change in measured voltage; wherein velocity of the object is calculated by the dividing the known distance by time between voltage changes.

In an illustrative embodiment, the device can be scaled to measure the velocity of objects of any size. In an illustrative embodiment, the device can measure the velocity of the objects in motion without regard to a minimum velocity. In an illustrative embodiment, the device further comprises one or more control boxes containing electronics for controlling the emitters and receivers. In an illustrative embodiment, the objects are dispensed through the first and second photoelectric sensor rings via a dispenser. In an illustrative embodiment, the first and second emitters and the first and second receivers are configured in a repeating patter comprising first emitter, second emitter, first receiver, second receiver. In an illustrative embodiment, the first and second emitters and the first and second receivers differ in modulation frequency to prevent crosstalk therebetween.

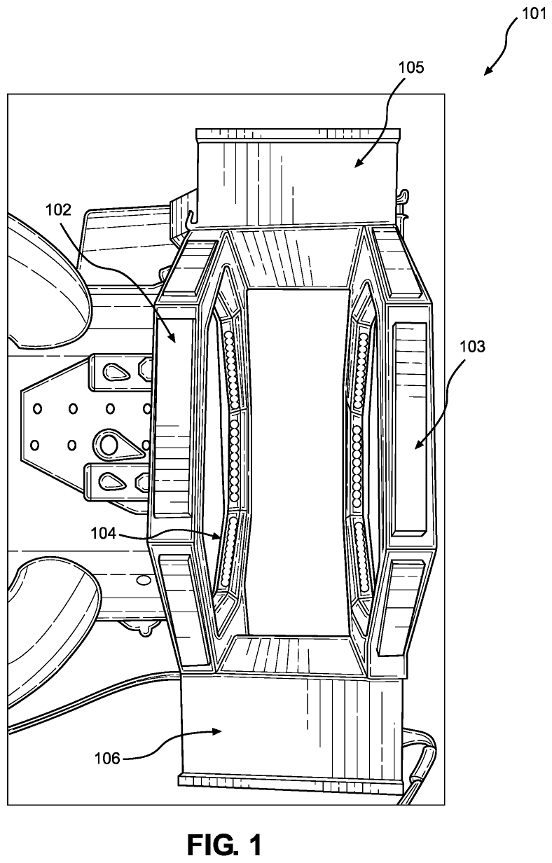

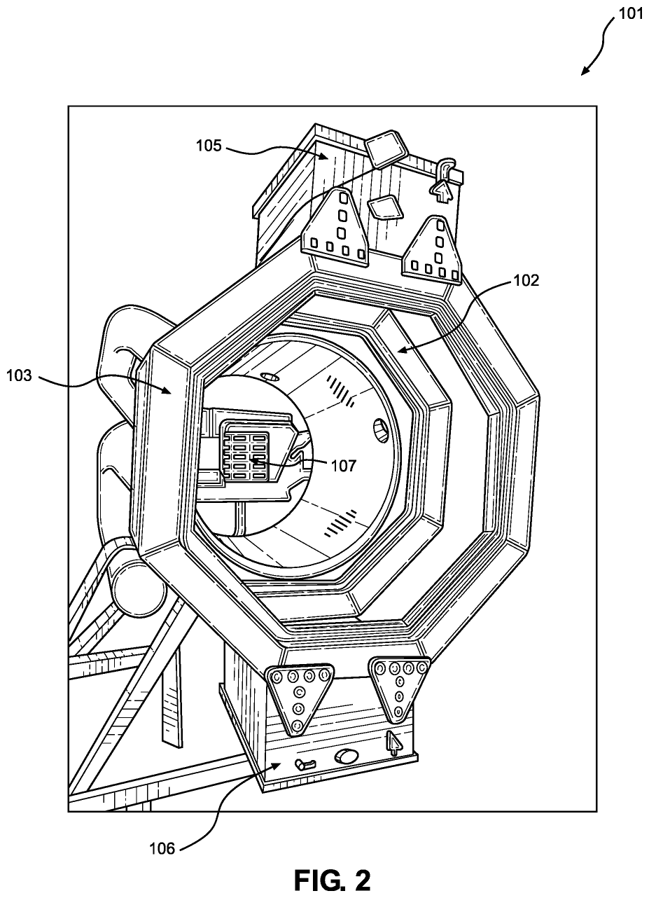

FIG. 1 shows a side view of a measurement device 101, and FIG. 2 shows a perspective view of a measurement device 101. In an illustrative embodiment, the device includes a first and a second photoelectric sensor ring 102, 103 spaced a known distance apart. The first and second photoelectric sensor rings 102, 103 include a repeating pattern of emitters and receivers 104, which will be discussed in greater detail below. One or more control boxes contains the electronics for controlling the emitters and receivers 104. In an illustrative embodiment, the device includes a first and second control box 105, 106. In an alternate embodiment, the device can utilize a single control box. In an illustrative embodiment, the control box can include a processor for calculating velocity. In an illustrative embodiment, an object to be measured is dispensed through the dispenser 107 so that its velocity can be measured as it passes by the first and second photoelectric sensor rings 102, 103.

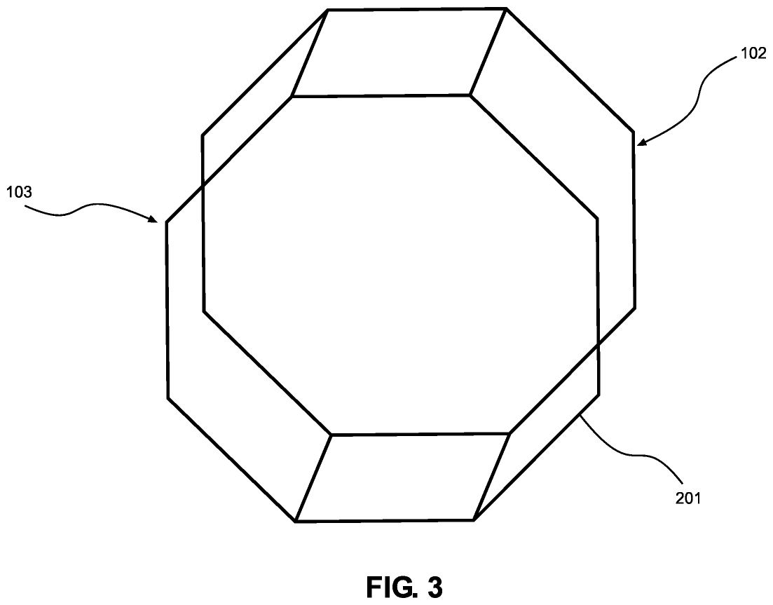

FIG. 3 shows a view of ring spacing. Due to the physical size of the individual sensors, the shape of the sensor rings 102, 103 becomes important. Early attempts at creating sufficient sensor coverage utilize square sensor rings, however, the square shape did not allow enough overlap in the center of the ring to catch small items traveling through the path. In an illustrative embodiment, the rings can be configured as octagons 201 to allow for increased intersection of light paths without the complication of a curved structure (circular rings). In an illustrative embodiment, the rings can be configured as circular rings.

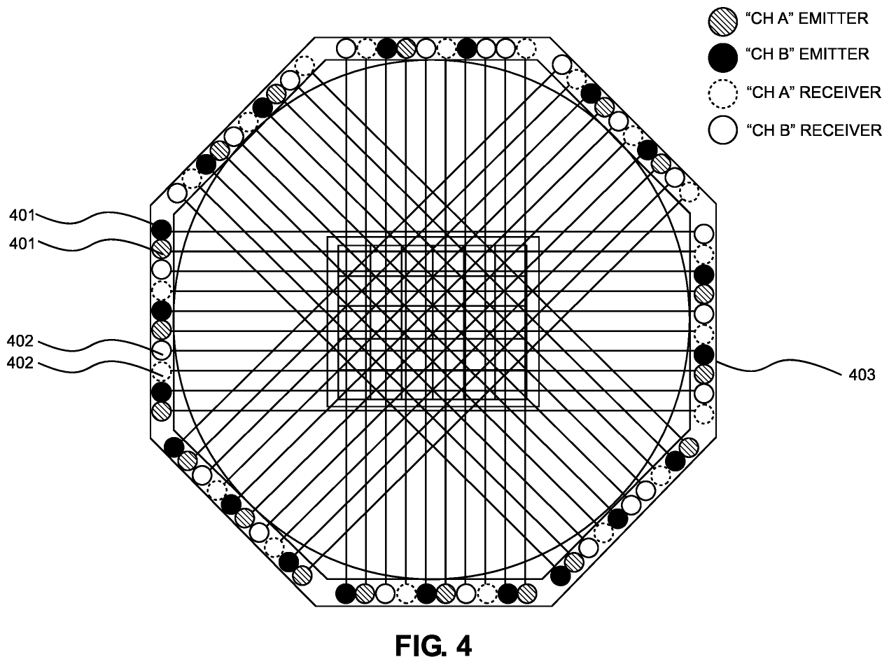

FIG. 4 shows a schematic of emitters 401 and receivers 402 spaced around a ring 403. In an illustrative embodiment, the photoelectric sensor pair includes an emitter 401 and a receiver 402. The emitter 401 sends the signal “out” and the receiver 402 takes the signal “in”. In an illustrative embodiment, the device utilizes two different types of photoelectric sensors, channels A and B that slightly differ in their modulation frequency (speed at which the light blinks). In an illustrative embodiment, the order of emitters 401 and receivers 402 around the sensor ring 403 is Channel A emitter, Channel B emitter, Channel A receiver, Channel B receiver. As can be appreciated, this order prevents crosstalk by ensuring that each receiver 402 is only in the path of a single emitter 401. If all of the emitters 401 were on the same side of the ring 403 (with the corresponding receivers 402 on the other side) the device would end up with receivers 402 receiving signal from more than one emitter 401, leading to potential for inaccurate measurement due to cross-talk.

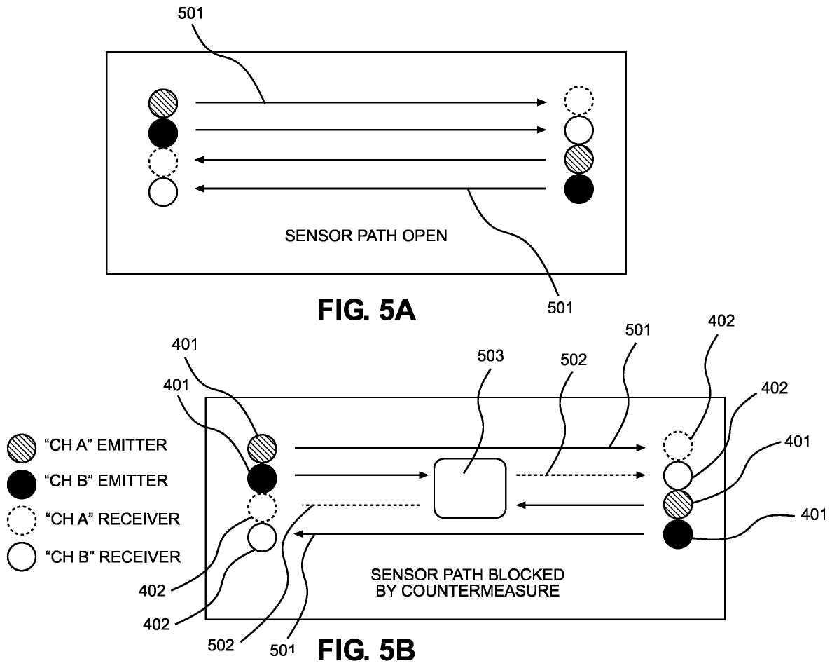

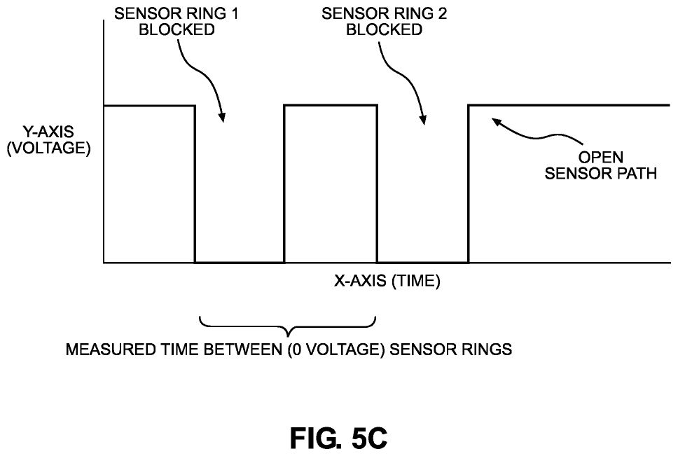

FIG. 5A shows a view of an open sensor path 501, FIG. 5B shows a view of a sensor path 502 blocked by an object 503, and FIG. 5C shows a graphical view of a sensor path blocked by an object. The receiver 402 can only detect signal at the frequency of the emitter 401. Without an object 503 blocking the emitter 401 to receiver 402 path, the receivers 402 register full signal. If an object 503 blocks the path, signal 502 is not received. If signal is not received for any sensor pair 401, 402 the voltage from the sensor ring changes from 10 V to 0 V, as shown in FIG. 5C. Voltage measurement is easily automated and recorded so this process requires no user input

### Experimental

An experiment was performed to determine the accuracy of the device. The inventive device was utilized to determine speed of an object passing through a first and second photoelectric sensor ring. In this experimental, the voltage was recorded at a rate of 1000 samples per second, and when the object crossed through the sensor rings a voltage change (10 V to 0 V) was detected and recorded. The distance between the rings for this experiment was 10 inches, which was then divided by the time between voltage changes (0.005 seconds) to calculate velocity. Formula 1 was utilized to determine the velocity of the object, which was calculated at 167 ft/2.

$$\frac{10 inches * ( 1 ft / 12 in )}{0.005 s} = 167 ft / s , calculation of velocity \qquad Formula 1$$

This velocity was verified utilizing a high speed video with a backer board having known markings. A video of the experiment was recorded and the number of video frames between the item crossing two lines on the backer board was determined to calculate the velocity, which was determined to be 167 ft/s, thereby verifying the accuracy of the inventive device.

In an illustrative embodiment, the device uses voltage and time to directly calculate speed. In an illustrative embodiment, voltage and time can be measured using industry standard techniques and can be automated for limiting user interaction. In an illustrative embodiment, samples can be taken at a rate of 1,000 to 50,000 samples/second or more. Text files of time and voltage are significantly smaller to store for record keeping than high-speed video files. Since there are no user defined time points, accuracy of measurement is greatly increased.

In an illustrative embodiment, the sensors are configured such that small objects can be measured. In an illustrative embodiment, the ability to measure an object is based on size, emitter/receiver power, and sensor ring distance. In an illustrative embodiment, objects smaller than 0.75 inch diameter can be measured by decreasing the size of emitters and decreasing distance between the emitter and receiver pair. In an illustrative embodiment, the inventive device is capable of measuring speeds in motion without regard to a minimum velocity (in a non-limiting example 60-200 ft/s), which is much slower than conventional chronographs. In an illustrative embodiment, issues related to ambient light and/or photonic energy from an object to be measured are eliminated by using frequency matched emitters and receivers.

In an illustrative embodiment, the inventive device can used for any application that requires velocity measurement of relatively small (larger objects can be measured as well), slow moving objects. A non-limiting example includes measurement of the ejection velocity of infrared and radar frequency countermeasures in real-time during lot acceptance and surveillance testing. Another non-limiting example includes measuring the velocity of pyrotechnic devices such as fireworks or signal flares. Another non-limiting example includes calculating velocity by dropping an object through the rings to measure the velocity of falling objects.

Although the invention has been described in detail with reference to certain preferred embodiments, variations and modifications exist within the spirit and scope of the invention as described and defined in the following claims.

1. A device for measuring velocity of an object comprising:
a first and a second photoelectric sensor ring spaced a known distance apart;
said first and second photoelectric sensor rings further comprising a repeating pattern of first and second emitters and first and second receivers;
wherein a signal is transmitted between said first and second emitters and said first and second receivers and is measured at a predefined rate;
wherein an object is passed through said first and second photoelectric sensor rings, blocking said signal and causing a change in measured voltage;
wherein said velocity of said object is calculated by said dividing said known distance by time between voltage changes.

2. The device of claim 1, wherein said device can be scaled to measure said velocity of said objects of any size.

3. The device of claim 1, wherein said device can be scaled to measure objects in motion without regard to a minimum velocity.

4. The device of claim 1, further comprising one or more control boxes containing electronics for controlling said emitters and receivers.

5. The device of claim 1, wherein said objects are dispensed through said first and second photoelectric sensor rings via a dispenser.

6. The device of claim 1, wherein said first and second emitters and said first and second receivers are configured in a repeating patter comprising first emitter, second emitter, first receiver, second receiver.

7. The device of claim 1, wherein said first and second emitters and said first and second receivers differ in modulation frequency to prevent crosstalk therebetween.

8. A device for measuring velocity of objects comprising:
a first and a second photoelectric sensor ring spaced a known distance apart;
said first photoelectric sensor ring further comprising a repeating pattern of first and second emitters and first and second receivers;
said second photoelectric sensor ring further comprising a corresponding pattern of first and second receivers and first and second emitters that correspond with said repeating pattern of said first photoelectric sensor ring;
wherein said first emitters and said first receivers have a first matched modulation frequency, and said second emitters and second receivers have a second matched modulation frequency;
wherein a signal is transmitted between said first and second emitters and said first and second receivers and is measured at a predefined rate;
wherein an object is passed through said first and second photoelectric sensor rings, blocking said signal and causing a change in measured voltage;
wherein velocity of said object is calculated by said dividing said known distance by time between voltage changes.

9. The device of claim 8, wherein said device can be scaled to measure said velocity of said objects of any size.

10. The device of claim 8, wherein said device can be scaled to measure objects in motion without regard to a minimum velocity.

11. The device of claim 8, further comprising one or more control boxes containing electronics for controlling said emitters and receivers.

12. The device of claim 8, wherein said objects are dispensed through said first and second photoelectric sensor rings via a dispenser.

13. The device of claim 8, wherein said first and second emitters and said first and second receivers are configured in a repeating patter comprising first emitter, second emitter, first receiver, second receiver.

14. The device of claim 8, wherein said first and second emitters and said first and second receivers differ in modulation frequency to prevent crosstalk therebetween.
